(19) United States
(12) Patent Application Publication
(10) Pub. No.: US 2025/0240840 A1
(43) Pub. Date: Jul. 24, 2025

(54) ELECTRONIC DEVICE AND CONTROL METHOD THEREFOR

(71) Applicant: Samsung Electronics Co., Ltd., Suwon-si (KR)

(72) Inventors: Hyungyong LEE, Suwon-si (KR); Jehwan SEO, Suwon-si (KR); Minkyu LEE, Suwon-si (KR)

(21) Appl. No.: 19/176,772

(22) Filed: Apr. 11, 2025

Related U.S. Application Data
(63) Continuation of application No. PCT/KR2023/017142, filed on Oct. 31, 2023.

(30) Foreign Application Priority Data
Dec. 28, 2022 (KR) 10-2022-0187107

(51) Int. Cl. H04W 76/14; H04W 52/02

(52) U.S. Cl. CPC H04W 76/14; H04W 52/0229

(57) ABSTRACT

An electronic device may include a communication module, memory, and one or more processors connected to the communication module and the memory to control the electronic device. The communication module may be configured to identify whether the electronic device is in a state of performing communication according to a preset communication method while in a standby mode, based on identifying that the electronic device is not in a state of performing communication, identify whether at least one external device connectable according to a preset communication method through the communication module is present, and based on identifying that the at least one external device is present, transmit a wake-up signal to the one or more processors. The one or more processors may be configured to acquire communication connection information corresponding to the at least one external device by performing pairing with the identified at least one external device through the communication module, and store the acquired communication connection information in the memory.

### CROSS-REFERENCE TO RELATED APPLICATIONS

This application is a continuation application of International Application No. PCT/KR2023/017142 designating the United States, filed on Oct. 31, 2023, in the Korean Intellectual Property Receiving Office and claiming priority to Korean Patent Application No. 10-2022-0187107, filed on Dec. 28, 2022, the disclosures of which are all hereby incorporated by reference herein in their entireties.

### BACKGROUND

### Technical Field

Certain example embodiments may relate to an electronic device and/or a controlling method thereof, and for example to, an electronic device that performs communication with an electronic device and/or a controlling method thereof.

### Background Art

The 21st century is called the information age. In order to become a leader in the information age, it is essential to have a means to acquire information as much and as quickly as possible. There was a time when desktop PCs and other stationary terminals were used as representative information and communication devices, but in the 21st century, mobile devices such as mobile phones, laptops, earphones, and headphones have become popular.

Various wireless communication technologies are being developed for these mobile devices. Bluetooth is a short-range wireless technology standard that connects mobile devices such as mobile phones, laptops, earphones, and headphones to exchange information. It is mainly used when low-power wireless connection is required at an ultra-short distance of about 10 meters. For example, using a Bluetooth headset, it is possible to listen to music from your smartphone in your pocket without the hassle of using cables.

### SUMMARY

An electronic device according to an example embodiment may include a communication module comprising communication circuitry, memory, and one or more processors comprising processing circuitry connected, directly or indirectly, to the communication module and the memory to control the electronic device. The communication module may be configured to identify whether the electronic device is in a state of performing communication according to a preset communication method while in a standby mode, based on identifying that the electronic device is not in a state of performing communication, identify whether at least one external device connectable according to a preset communication method through the communication module is present, and based on identifying that the at least one external device is present, transmit a wake-up signal to the one or more processors. The one or more processors may be individually and/or collectively configured to acquire communication connection information corresponding to the at least one external device by performing pairing with the identified at least one external device through the communication module, and store the acquired communication connection information in the memory.

The one or more processors may be individually and/or collectively configured to, based on waking up from the standby mode based on the wake-up signal, perform pairing with the identified at least one external device to establish a communication connection and acquire communication connection information corresponding to the at least one external device, and store the acquired communication connection information in the memory, disconnect the communication connection with the at least one external device and switch to the standby mode.

The one or more processors may be individually and/or collectively configured to identify whether the electronic device is in a state of performing communication according to the preset communication method while the electronic device is in a turn-on state, based on identifying that the electronic device is not in a state of performing communication, identify whether at least one external device connectable according to a preset communication method through the communication module is present, based on identifying that the at least one external device is present, perform paring with the identified at least one external device in a background mode to establish a communication connection and acquire communication connection information corresponding to the at least one external device, and store the acquired communication connection information in the memory, disconnect the communication connection with the at least one external device, and switch to the standby mode.

The one or more processors may be individually and/or collectively configured to, based on the communication connection with the at least one external device whose communication connection information is stored being permitted according to a user command, perform communication without pairing with the at least one external device based on the communication connection information.

The one or more processors may be individually and/or collectively configured to control the display to display a UI including identification information for the at least one external device whose communication connection information is stored according to a user command, and based on the communication connection with the at least one external device being permitted according to the user command received through the UI, perform communication without paring with the at least one external device based on the communication connection information.

The device may further include a display, and the one or more processors may be individually and/or collectively configured to wake up the electronic device from the standby mode based on the wake-up signal with a screen of the display turned off, and perform pairing with the identified at least one external device to acquire communication connection information corresponding to the at least one external device.

A preset communication method may be a Bluetooth communication method for example, and the communication module may be configured to, based on the communication module being in at least one of an audio signal transmission state or a state in which a communication connection with an external device is established, identify that it is a state in which communication is performed according to the Bluetooth communication method, and based on Bluetooth communication using a bandwidth greater than a threshold size being performed, identify that it is a state in which communication is performed according to the Bluetooth communication method.

The communication module may be configured to broadcast a scan signal while the electronic device is in a standby mode, and based on identifying that the electronic device is not in a state of performing communication, identify at least one external device connectable according to the preset communication method based on a response signal to the scan signal.

The one or more processors may be individually and/or collectively configured to, based on pairing with a first external device among the identified at least one external device being and/or having failed, not proceed with a pairing procedure with the first external device when the first external device is identified in a standby mode.

A controlling method of an electronic device according to an example embodiment may include identifying whether the electronic device is in a state of performing communication according to a preset communication method while in a standby mode, based on identifying that the electronic device is not in a state of performing communication, identifying whether at least one external device connectable according to a preset communication method through the communication module is present, based on identifying that the at least one external device is present, waking up the electronic device, and acquiring communication connection information corresponding to the at least one external device by performing pairing with the identified at least one external device through the communication module, and storing the acquired communication connection information in the memory.

The method may further include storing the acquired communication connection information in the memory, disconnecting the communication connection with the at least one external device and switching to the standby mode.

The method may further include identifying whether the electronic device is in a state of performing communication according to the preset communication method while the electronic device is in a turn-on state, based on identifying that the electronic device is not in a state of performing communication, identifying whether at least one external device connectable according to a preset communication method through the communication module is present, based on identifying that the at least one external device is present, performing paring with the identified at least one external device in a background mode to establish a communication connection and acquiring communication connection information corresponding to the at least one external device, and storing the acquired communication connection information, disconnecting the communication connection with the at least one external device, and switching to the standby mode

The method may further include, based on the communication connection with the at least one external device whose communication connection information is stored being permitted according to a user command, performing communication without pairing with the at least one external device based on the communication connection information.

The method may further include providing a UI including identification information for the at least one external device whose communication connection information is stored according to a user command, and based on the communication connection with the at least one external device being permitted according to the user command received through the UI, performing communication without paring with the at least one external device based on the communication connection information.

The storing the acquired communication connection information may include waking up the electronic device from the standby mode based on the wake-up signal with a screen of the display turned off, and performing pairing with the identified at least one external device to acquire communication connection information corresponding to the at least one external device.

The preset communication method may be a Bluetooth communication method, and the identifying whether the electronic device is in a state of performing communication may include, based on the communication module being in at least one of an audio signal transmission state or a state in which a communication connection with an external device is established, identifying that it is a state in which communication is performed according to the Bluetooth communication method, or based on Bluetooth communication using a bandwidth greater than a threshold size being performed, identifying that it is a state in which communication is performed according to the Bluetooth communication method.

The method may further include broadcasting a scan signal while the electronic device is in a standby mode, and the identifying whether the at least one external device is present may include, based on identifying that the electronic device is not in a state of performing communication, identify at least one external device connectable according to the preset communication method based on a response signal to the scan signal.

The method may further include, based on pairing with a first external device among the identified at least one external device being and/or having failed, not proceeding with a pairing procedure with the first external device when the first external device is identified in a standby mode.

In an example non-transitory computer-readable recording medium storing a computer instruction that may, when executed by a processor(s) of an electronic device, cause the electronic device to perform operations, the operations may include identifying whether the electronic device is in a state of performing communication according to a preset communication method while in a standby mode, based on identifying that the electronic device is not in a state of performing communication, identifying whether at least one external device connectable according to a preset communication method through the communication module is present, based on identifying that the at least one external device is present, waking up the electronic device, and acquiring communication connection information corresponding to the at least one external device by performing pairing with the identified at least one external device through the communication module, and storing the acquired communication connection information.

### BRIEF DESCRIPTION OF DRAWINGS

FIG. 1 is a view provided to schematically explain an operation of an electronic device according to an example embodiment;

FIG. 2A is a block diagram illustrating configuration of an electronic device according to an example embodiment;

FIG. 2B is a block diagram illustrating configuration of an electronic device in detail according to an example embodiment;

FIG. 3 is a flowchart provided to explain a controlling method of an electronic device according to an example embodiment;

FIG. 4 is a flowchart provided to explain a controlling method of an electronic device according to an example embodiment;

FIGS. 5 and 6 are views provided to explain an operation between an electronic device and an external device according to an example embodiment;

FIG. 7 is a flowchart provided to explain a controlling method of an electronic device according to an example embodiment; and

FIG. 8 is a flowchart provided to explain a controlling method of an electronic device according to an example embodiment.

### DETAILED DESCRIPTION

The terms used in the present disclosure will be briefly described before the present disclosure is described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the embodiments of the disclosure need to be defined on the basis of the meanings of the terms and the overall contents throughout the disclosure rather than simple names of the terms.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element). Thus, “connected” as used herein covers both direct and indirect connections.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

In some cases, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘˜er’ may perform at least one function or operation, and be implemented as hardware or software or be implemented as a combination of hardware and software. In addition, a plurality of ‘modules’ or a plurality of ‘˜er’ may be integrated into at least one module and be implemented as at least one processor (not shown) except for a ‘module’ or a ‘˜er’ that needs to be implemented as specific hardware. Thus, each “module” herein may comprise circuitry.

Meanwhile, various elements and regions in the drawings are schematically drawn in the drawings. Therefore, the technical concept of the disclosure is not limited by a relative size or spacing drawn in the accompanying drawings.

Hereinafter, an example embodiment will be described in greater detail with reference to the accompanying drawings.

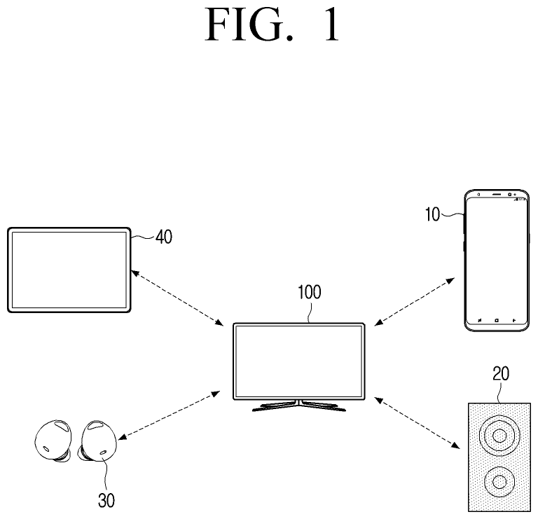

FIG. 1 is a view provided to schematically explain an operation of an electronic device according to an embodiment.

Referring to FIG. 1, an electronic device 100 may be implemented as a television, a smart TV, a laptop computer, a notebook computer, etc., but is not limited thereto.

According to an embodiment, the electronic device 100 may be communicatively connected to peripheral devices 10, 20, 30, 40 according to a preset communication method. For example, the electronic device 100 may be communicatively connected to the peripheral devices 10, 20, 30, 40 according to the Bluetooth communication method.

In order for the electronic device 100 to establish a Bluetooth communication connection with the peripheral devices 10, 20, 30, 40, the peripheral device must be registered by performing a pairing process between devices. However, when the electronic device 100 is communicatively connected to a specific Bluetooth device, there is a limitation in pairing and registering a Bluetooth device with the same function.

Accordingly, when the electronic device 100 is turned off and not in use, or is turned on but the Bluetooth communication function is not in use (or the usage rate is low), it may be very efficient to perform automatic pairing of peripheral devices to register the devices.

Accordingly, various embodiments of automatically connecting and registering a Bluetooth device without any separate operation by the user will be described below with reference to the drawings.

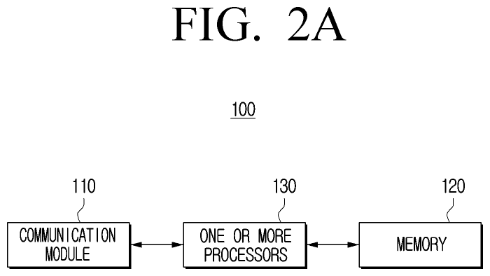

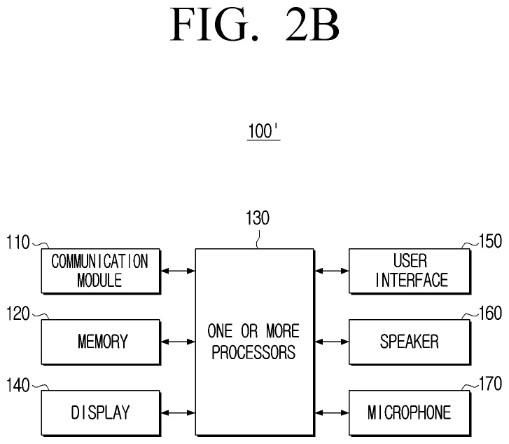

FIG. 2A is a block diagram illustrating configuration of an electronic device according to an embodiment.

Referring to FIG. 2A, the electronic device 100 may include a communication module 110 comprising communication circuitry, memory 120, and one or more processors 130 each comprising processing circuitry.

The communication module 110 may be implemented as a Bluetooth communication module. However, the communication module 110 is not limited thereto and may of course be implemented as any other communication module having a protocol similar to Bluetooth communication. The communication module 110 may be implemented as a Bluetooth module including a Bluetooth transceiver, such as a hardware module (or chip). The Bluetooth module may function as an interface that supports wireless Bluetooth low energy connection of two devices and establishes a protocol for data communication between the devices. The medium data communication range of the Bluetooth low energy module is typically tens of meters on average, and the data may be communicated in a specified frequency band.

The memory 120 may store data required for various embodiments of the present disclosure. The memory 120 may be implemented as a memory embedded in the electronic device 100 or as a memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100. Meanwhile, the memory embedded in the electronic device 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the electronic device 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

The one or more processors 130 may control the overall operations of the electronic device 100. Specifically, the one or more processors 130 may be connected, directly or indirectly, to each component of the electronic device 100 and control the overall operations of the electronic device 100. For example, the one or more processors 130 may be electrically connected, directly or indirectly, to the display 170 and the memory 120 to control the overall operations of the electronic device 100. The one or more processors 130 may consist of one or multiple processors.

The one or more processors 130, by executing at least one instruction stored in the memory 120, may perform the operations of the electronic device 100 according to various embodiments.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or any combination of the other components of the display device, and may perform communication-related operations or data processing. The one or more processors 130 may execute at least one program or instruction stored in the memory. For example, the one or more processors 130 may perform a method according to an embodiment by executing at least one instruction stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 130 may be implemented as a single core processor including a single core, or as one or more multicore processors including a plurality of cores (e.g., homogeneous multicore or heterogeneous multicore). When the one or more processors 130 are implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the core is not limited to the embodiments of the present disclosure. Hereinafter, the one or more processors 130 will be referred to as the processor 130 for convenience of explanation.

FIG. 2B is a block diagram illustrating configuration of an electronic device in detail according to an embodiment.

Referring to FIG. 2B, an electronic device 100′ may include the communication module 110, the memory 120, the one or more processors 130, a display 140, a user interface 150, a speaker 160, and a microphone 170. A detailed description of the configurations illustrated in FIG. 2B that overlap with the configurations illustrated in FIG. 2A will be omitted.

The display 140 may be implemented as a display including a self-light emitting device or a display including a non-light emitting device and a backlight. For example, the display 140 may be implemented as various types of displays such as liquid crystal display (LCD), organic light emitting diodes (OLED) display, Light Emitting Diodes (LED), micro LED, Mini LED, Plasma Display Panel (PDP), Quantum dot (QD) display, quantum dot light-emitting diode (QLED) display, and the like. The display 140 may also include a driving circuit, a backlight unit, and the like, which may be implemented in the form of amorphous silicon thin film transistor (a-si TFTs), low temperature poly silicon (LTPS) TFTs, organic TFTs (OTFTs), and the like. According to an embodiment, a touch sensor that detects a touch operation in the form of a touch film, a touch sheet, a touch pad, etc. may be disposed on the front of the display 140 to detect various types of touch inputs. For example, the display 170 may detect various types of touch inputs, such as a touch input by the user's hand, a touch input by an input device such as a stylus pen, and a touch input by a specific electrostatic material. According to an embodiment, the display 140 may be implemented as a flat display, a curved display, a flexible display that can be folded or/and rolled, etc.

The user interface 150 may be implemented as a device such as a button, a touch pad, a mouse, and a keyboard, or may be implemented as a touch screen that can also perform the display function and the manipulation input function described above.

The speaker 160 may be configured to output various audio data as well as various notification sound or voice messages.

The microphone 170 may be configured to receive the user's voice or other sound and convert it into audio data.

Meanwhile, although FIG. 2A describes that the communication module 110 is limited to a Bluetooth communication module, the electronic device 100′ may additionally support various communication methods depending on the implementation example. For example, it is possible to perform communication with an external device, an external storage medium (e.g., USB memory), an external server (e.g., cloud server) comprising circuitry, or the like through communication methods such as AP-based Wi-Fi (Wireless LAN Network), Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial, etc.

In addition, the electronic device 100′ may further include a camera (not shown), a tuner (not shown), and a demodulator (not shown). The camera (not shown) may be turned on according to a preset event to perform shooting. However, according to another embodiment, the electronic device 100′ may receive a user voice input through an external device through the communication module 110. The tuner (not shown) may tune a channel selected by the user or all pre-stored channels among Radio Frequency (RF) broadcast signals received through an antenna to receive an RF broadcast signal. The demodulator (not shown) may receive a digital IF signal (DIF) converted by the tuner, demodulate it, and perform channel decoding, etc.

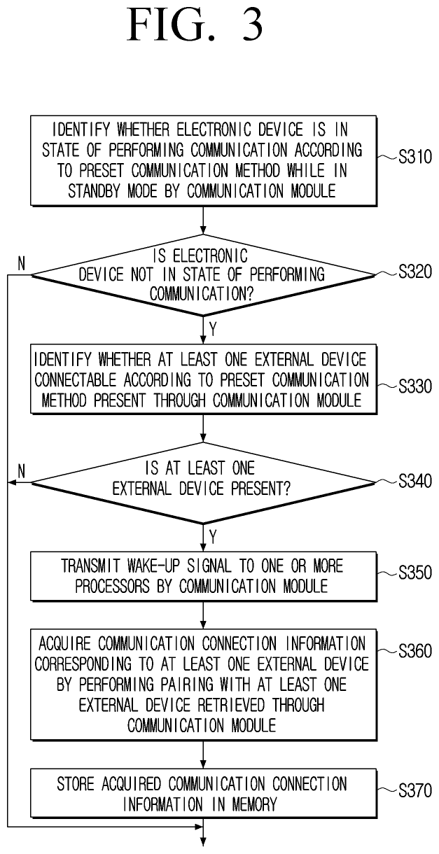

FIG. 3 is a flowchart provided to explain a controlling method of an electronic device according to an embodiment.

According to an embodiment illustrated in FIG. 3, the communication module 110 may identify whether the communication module 110 is in a state of performing communication according to a preset communication method (S310). According to an embodiment, the preset communication method may be Bluetooth communication.

According to an embodiment, while the electronic device 100 is in a standby mode, the communication module 110 may identify whether the communication module 110 is in a state of performing communication according to a preset communication method.

While the electronic device 100 is in a standby mode, the communication module 110 may be activated, e.g., turned on, but most of the functions of the electronic device 100 (e.g., host functions such as a display function, etc.) may be turned off. This is because the communication module 110 must be activated to receive Bluetooth control signals such as a signal to turn on the electronic device 100 even when the electronic device 100 is in a standby mode.

According to another embodiment, even when the electronic device 100 is not in a standby mode, it is possible to identify whether the communication module 110 is in a state of performing communication according to a preset communication method. In other words, even if the electronic device 100 is turned on, the communication module 110 may not be in a state of performing communication.

However, hereinafter, the case where the electronic device 100 performs an operation according to an embodiment in a standby mode will be preferentially described for convenience of explanation.

When it is identified that the communication module 110 is not in a state of performing communication (S320: Y), it may be identified whether at least one external device connectable through the communication module 110 is present (S330). For example, when it is identified that the communication module 110 is not in a state of performing communication while the electronic device 100 is in a standby mode (S320: Y), it may be identified whether at least one external device connectable through the communication module 110 is present (S330).

According to an embodiment, the communication module 110 may be identified as being in a state of performing communication according to the Bluetooth communication method when it is in at least one of a state of transmitting an audio signal or a state of being communicatively connected, directly or indirectly, to an external device. Further, the communication module 110 may be identified as being in a state of performing communication according to the Bluetooth communication method when it is performing Bluetooth communication using a bandwidth greater a threshold size. For example, the communication module 110 may be identified as being in a state of performing communication when a major service that uses a lot of communication bandwidth, such as A2DP (audio transmission), HID (keyboard, mouse, etc.), is in use.

On the other hand, the communication module 110 may be identified as being not in a state of performing communication when it is in a state of performing Bluetooth communication using a bandwidth below a threshold size or hardly using a bandwidth.

According to an embodiment, the communication module 110 may broadcast a scan signal while the electronic device 100 is in a standby mode. In addition, when it is identified that the communication module 110 is not in a state of performing communication, at least one external device that is communicatively connectable based on a response signal to the scan signal may be identified.

For example, the communication module 110 may broadcast a BLE scan signal (or a BLE scan packet or an inquiry request packet). In this case, an external device that receives the BLE scan signal may transmit a BLE advertising signal (or a BLE advertising packet or an inquiry response packet). Accordingly, the communication module 110 may identify whether there is an external device capable of Bluetooth connection by identifying the device that transmitted the BLE advertising signal for a preset time while in the communication connection mode.

When it is identified that at least one external device is present (S340: Y), a wake-up signal may be transmitted to the processor 130 (S350). Accordingly, the processor 130 that received the wake-up signal may wake up and the electronic device 100 may wake up.

In this case, the processor 130 may perform pairing with the at least one external device identified in step S330 through the communication module 110 to acquire communication connection information corresponding to the at least one external device (S360). The communication connection information may include various information required for establishing a Bluetooth communication connection, such as identification information of the external device, Mac address, communication band information, etc. For example, the identification information of the external device may include various identification information, such as manufacturer name, device name, model name, serial number, and the like.

Subsequently, the processor 130 may store the communication connection information acquired in step S360 in the memory 120 (S370). For example, the processor 130 may register the external device in a list of communication connection devices based on the communication connection information acquired in step S360.

Thereafter, a communication connection with at least one external device for which communication connection information is stored is permitted according to a user command, the processor 130 may perform communication with the at least one external device without pairing based on the communication connection information stored in the memory 120.

According to an embodiment, the processor 130 may wake up the electronic device 100 from a standby mode with the screen of the display 140 turned off based on the wake-up signal received from the communication module 110. This is because the wake-up signal received from the communication module 110 is a wake-up request for acquiring communication connection information of an external device capable of communication connection and thus, there is no need to turn on the screen of the display 140 that is unnecessary for acquiring communication connection information.

According to another example, when an operation according to S310 to S370 is performed while the electronic device 100 is turned on, the operation may be performed in a background mode. Even when the electronic device 100 is turned on, the main operation of the electronic device 100 will not be affected since the communication module 110 is not in use.

Meanwhile, according to an embodiment, in step S360, there may be a case where pairing with the first external device among the identified at least one external device fails. In this case, when the electronic device 100 subsequently enters the standby mode again, even if the first external device is identified as a device capable of communication connection in step S330, the subsequent procedure, e.g., pairing procedure, may not be performed with the first external device.

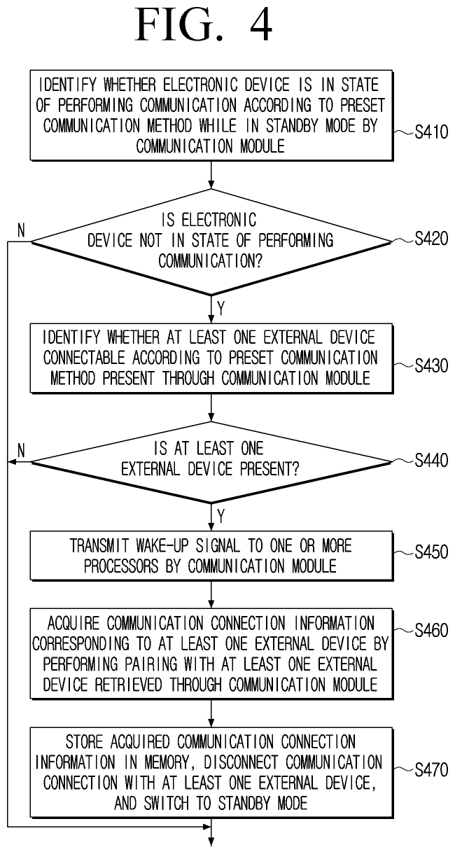

FIG. 4 is a flowchart provided to explain a controlling method of an electronic device according to an embodiment.

Among the steps illustrated in FIG. 4, steps S410 to S460 overlap with steps S310 to S360 illustrated in FIG. 3 and thus, will not be described in detail.

According to an embodiment, when communication connection information of at least one external device is acquired in step S460, the processor 130 may store the acquired communication connection information in the memory 120, and then disconnect the communication connection with the at least one external device and switch to a standby mode.

Subsequently, when a communication connection with the at least one external device for which communication connection information is stored is permitted according to a user command, the processor 130 may perform communication with the at least one external device without pairing based on the communication connection information stored in the memory 120. “Based on” as used herein covers based at least on.

As described in FIGS. 3 and 4, the processor 130 may perform pairing with a connectable external device while the communication module 110 is not in a state of performing communication and store the communication connection information of the external device in the memory 120, so a Bluetooth communication connection with the external device can be established subsequently without a pairing procedure. In other words, by automatically connecting a peripheral device in advance and pre-registering the communication connection information while the user is not using the electronic device 100, the user may connect multiple devices at once without a separate pairing process only by automatically activating the device (allowing the device to be used) when needed.

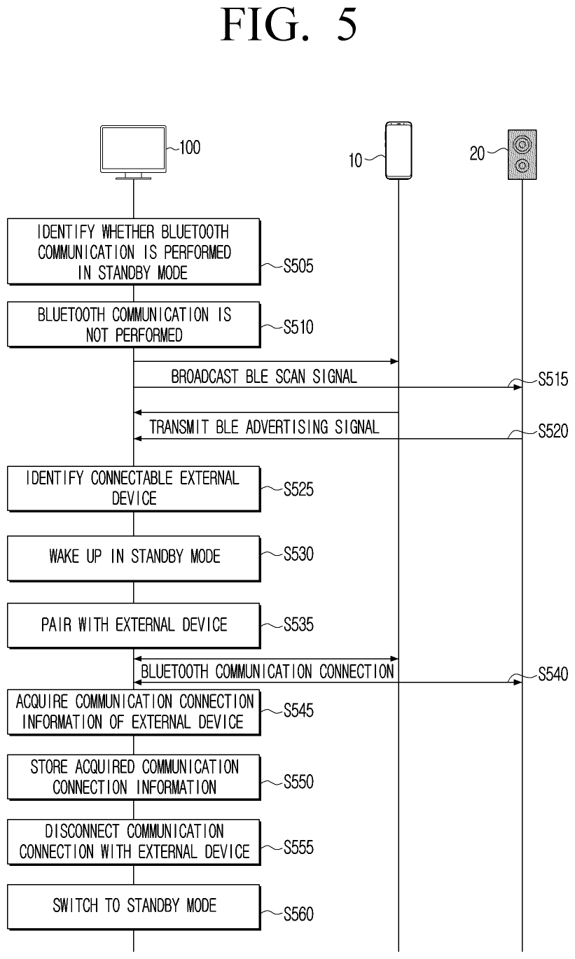

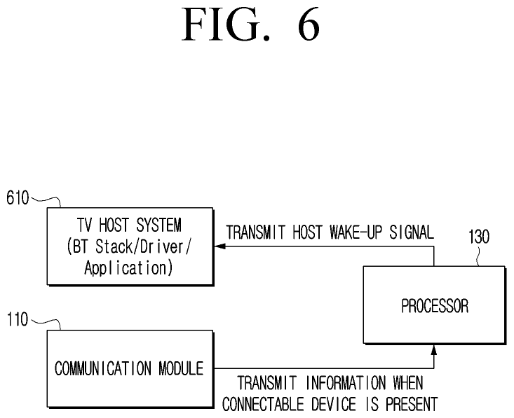

FIGS. 5 and 6 are views provided to explain an operation between an electronic device and an external device according to an embodiment.

According to the embodiment illustrated in FIG. 5, the electronic device 100 may identify whether Bluetooth communication is present in a standby mode (S505).

According to an embodiment, the communication module 110 performing Bluetooth communication may be identified as being in a state of performing communication according to the Bluetooth communication method when it is in at least one of a state of transmitting an audio signal or a state of being communicatively connected, directly or indirectly, to an external device. Further, the communication module 110 may be identified as being in a state of performing communication according to the Bluetooth communication method when it performs Bluetooth communication using a bandwidth greater than a threshold size. On the other hand, the communication module 110 may be identified as being not in a state of performing communication when it performs Bluetooth communication using a bandwidth below a threshold size or hardly using a bandwidth.

When the communication module 110 is not in a state of performing communication, the communication module 110 may broadcast a BLE scan signal (or BLE scan packet or inquiry request packet) (S515).

In this case, the external device 10, 20 that received the BLE scan signal may transmit a BLE advertising signal (or BLE advertising packet or inquiry response packet) (S520). The communication module 110 may identify the device 10, 20 that transmitted the BLE advertising signal to identify whether an external device capable of Bluetooth connection is present (S525).

Once the external device capable of Bluetooth connection is identified (S525), the electronic device 100 may wake up from the standby mode (S530).

According to an embodiment, it is assumed that the electronic device 100 is implemented as a television. For example, as illustrated in FIG. 6, when an external device capable of Bluetooth connection is identified in the communication module 110, the corresponding information may be transmitted to the processor 130, and the processor 130 may transmit a wake-up signal to a TV Host system so that the electronic device 100 can wake up. Here, the processor 130 may be implemented as at least one of a controller, for example, a microcomputer or a power control circuit, but is not limited thereto.

Upon waking up from the standby mode, the electronic device 100 may perform pairing with the external device 10, 20 that transmitted the BLE advertising signal (S535) to establish a Bluetooth communication connection (S540). During this process, the electronic device 100 may acquire communication connection information of the external device 10, 20 (S545).

Subsequently, the electronic device 100 may store the acquired communication connection information of the external device 10, 20 (S550), and may disconnect the communication connection with the external device 10, 20 (S555). In other words, the electronic device 100 may register the acquired external device 10, 20 in a list of communication connection devices and disconnect the Bluetooth communication connection with the external device 10, 20.

Thereafter, the electronic device 100 may enter an initial mode, e.g., standby mode (S560).

Accordingly, the electronic device 100 may thereafter establish a Bluetooth communication connection with the corresponding external devices 10, 20 when needed, without a pairing procedure.

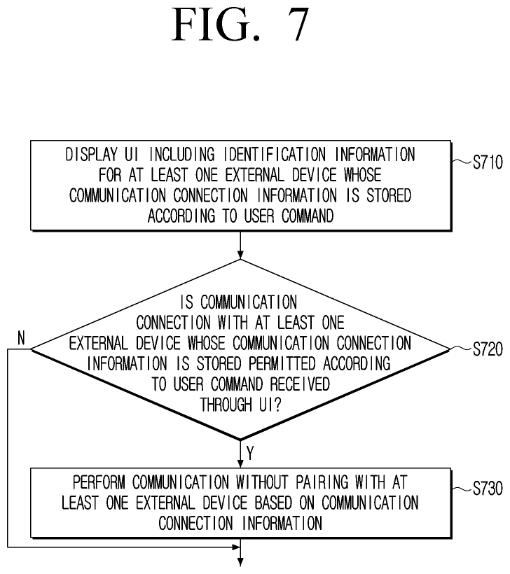

FIG. 7 is a flowchart provided to explain a controlling method of an electronic device according to an embodiment.

According to the embodiment illustrated in FIG. 7, the processor 130 may, upon a user command, display a UI through the display 130 that includes identification information for at least one external device whose communication connection information is stored in the memory 120 (S710).

Subsequently, the processor 130 may identify whether a communication connection with at least one external device is permitted according to a user command received through the UI (S720).

When the communication connection with the at least one external device is permitted (S720: Y) according to a user command received through the UI, the processor 130 may perform communication with the at least one external device without pairing based on the communication connection information.

Accordingly, the electronic device 100 may thereafter establish a Bluetooth communication connection with the corresponding external device when needed, without a pairing procedure, by using the communication connection information of the external device acquired in a standby mode or background mode.

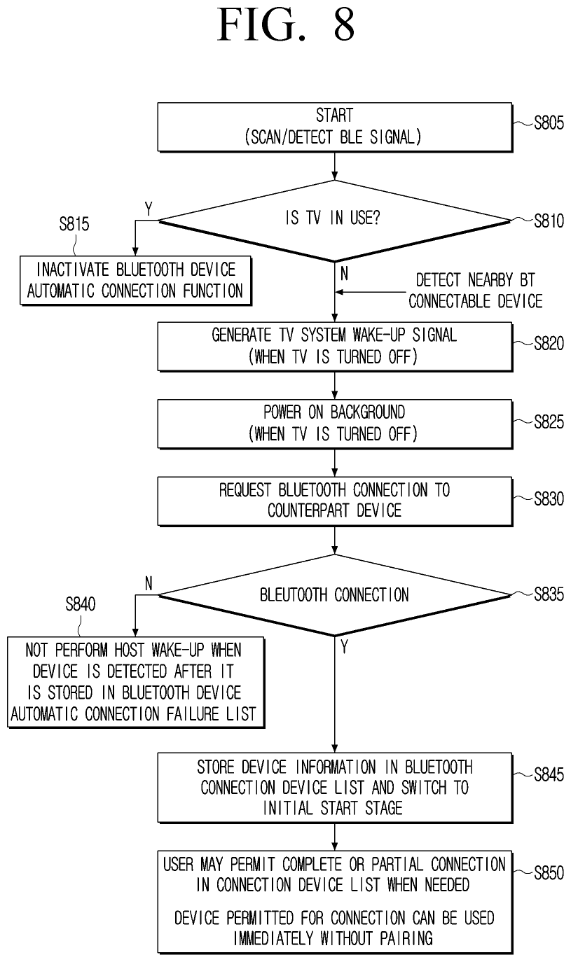

FIG. 8 is a flowchart provided to explain a controlling method of an electronic device according to an embodiment.

According to an embodiment, it is assumed that the electronic device 100 is implemented as a television (TV).

According to the embodiment illustrated in FIG. 8, the TV may broadcast a BLE scan signal regardless of whether it is turned on or off (S805). For example, a Bluetooth communication module included in the TV may periodically broadcast a BLE scan signal in an activated state regardless of whether the TV is turned on or off.

When the TV is turned off and not in use (S810: N), when a peripheral device capable of Bluetooth connection is detected by a BLE scan signal, a signal to wake up the TV system for automatic Bluetooth device connection may be generated (S820). On the other hand, when the TV is in use (S810: Y), the Bluetooth device automatic connection function may be inactivated (S815).

As the TV system wake-up signal is generated (S820), when the background power-on mode is entered (S825), a Bluetooth connection request signal may be transmitted to the detected counterpart device (S830). Here, the background power-on mode may be a mode in which the Bluetooth device automatic connection function is performed in the background while the display screen is turned off.

When the Bluetooth connection is not established with the counterpart device according to the Bluetooth connection request signal (S835: N), the information of the corresponding device may be stored in the Bluetooth device connection failure list (S840). Accordingly, a TV system wake-up signal may not be generated even if the corresponding device is subsequently detected again. On the other hand, when the Bluetooth connection is established with the counterpart device according to the Bluetooth connection request signal (S835: Y), the TV may store the device information in the Bluetooth connection device list and switch to the initial start stage (S845). In other words, the background power-on mode for performing the Bluetooth device automatic connection function may be terminated.

Meanwhile, the user may select to allow batch or partial connection in a list of Bluetooth connection devices when needed, and the devices that are allowed to connect may be immediately communicatively connected and available for use without pairing (S850).

According to the various embodiments described above, by automatically connecting peripheral devices in advance and pre-registering communication connection information when the user is not using the devices, the user can connect multiple devices at once without a separate pairing process by simply activating the corresponding devices automatically (allowing use of the devices) when needed.

Meanwhile, the methods according to the various embodiments described above may be implemented in the form of an application that can be installed in an existing display device. Alternatively, the methods according to the various embodiments described above may be performed using a deep learning-based artificial neural network (or deep artificial neural network), e.g., a learning network model. According to an embodiment, at least one of downscaling, decoding, encoding, or upscaling may be performed through a trained neural network model.

In addition, the methods according to the various embodiments of the present disclosure described above may be implemented only with a software upgrade or a hardware upgrade for an existing display device.

Further, the various embodiments of the present disclosure described above may also be performed through an embedded server (comprising circuitry) provided in the display device or an external server (comprising circuitry) of the display device.

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include a display device (e.g., display device A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily generated.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a communication module comprising communication circuitry;
memory; and
one or more processors, comprising processing circuitry, connected to the communication module and the memory to control the electronic device,
wherein the communication module is configured to:
identify whether the electronic device is in a state of performing communication according to a preset communication method while in a standby mode;
based on identifying that the electronic device is not in a state of performing communication, identify whether at least one external device connectable according to a preset communication method through the communication module is present;
based on identifying that the at least one external device is present, transmit a wake-up signal to the one or more processors; and
wherein the one or more processors is/are individually and/or collectively configured to acquire communication connection information corresponding to the at least one external device at least by performing pairing with the identified at least one external device through at least the communication module, and store the acquired communication connection information in the memory.

2. The device as claimed in claim 1, wherein the one or more processors are individually and/or collectively configured to:
based on waking up from the standby mode based on the wake-up signal, perform pairing with the identified at least one external device to establish a communication connection and acquire communication connection information corresponding to the at least one external device; and
store the acquired communication connection information in the memory, disconnect the communication connection with the at least one external device and switch to the standby mode.

3. The device as claimed in claim 1, wherein the one or more processors are individually and/or collectively configured to:
identify whether the electronic device is in a state of performing communication according to the preset communication method while the electronic device is in a turn-on state;
based on identifying that the electronic device is not in a state of performing communication, identify whether at least one external device connectable according to a preset communication method through the communication module is present;
based on identifying that the at least one external device is present, perform paring with the identified at least one external device in a background mode to establish a communication connection and acquire communication connection information corresponding to the at least one external device; and
store the acquired communication connection information in the memory, disconnect the communication connection with the at least one external device, and switch to the standby mode.

4. The device as claimed in claim 2, wherein the one or more processors are individually and/or collectively configured to, based on the communication connection with the at least one external device whose communication connection information is stored being permitted according to a user command, perform communication without pairing with the at least one external device based on the communication connection information.

5. The device as claimed in claim 4, wherein the one or more processors are individually and/or collectively configured to:
control the display to display a UI including identification information for the at least one external device whose communication connection information is stored according to a user command; and
based on the communication connection with the at least one external device being permitted according to the user command received through the UI, perform communication without paring with the at least one external device based on the communication connection information.

6. The device as claimed in claim 2, further comprising:
a display,
wherein the one or more processors are individually and/or collectively configured to wake up the electronic device from the standby mode based on the wake-up signal with a screen of the display turned off, and perform pairing with the identified at least one external device to acquire communication connection information corresponding to the at least one external device.

7. The device as claimed in claim 1, wherein the preset communication method is a Bluetooth communication method; and
wherein the communication module is configured to:
based on the communication module being in at least one of an audio signal transmission state or a state in which a communication connection with an external device is established, identify that it is a state in which communication is performed according to the Bluetooth communication method; and/or
based on Bluetooth communication using a bandwidth greater than a threshold size being performed, identify that it is a state in which communication is performed according to the Bluetooth communication method.

8. The device as claimed in claim 1, wherein the communication module is configured to:
broadcast a scan signal while the electronic device is in a standby mode; and
based on identifying that the electronic device is not in a state of performing communication, identify at least one external device connectable according to the preset communication method based on a response signal to the scan signal.

9. The device as claimed in claim 1, wherein the one or more processors are individually and/or collectively configured to, based on pairing with a first external device among the identified at least one external device failing, not proceed with a pairing procedure with the first external device when the first external device is identified in a standby mode.

10. A controlling method of an electronic device, the method comprising:
identifying whether the electronic device is in a state of performing communication based on a preset communication method while in a standby mode;
based on identifying that the electronic device is not in a state of performing communication, identifying whether at least one external device connectable according to a preset communication method through the communication module is present;
based on identifying that the at least one external device is present, waking up the electronic device; and
acquiring communication connection information corresponding to the at least one external device at least by performing pairing with the identified at least one external device through at least the communication module, and storing the acquired communication connection information.

11. The method as claimed in claim 10, further comprising:
storing the acquired communication connection information in the memory, disconnecting the communication connection with the at least one external device and switching to the standby mode.

12. The method as claimed in claim 10, further comprising:
identifying whether the electronic device is in a state of performing communication according to the preset communication method while the electronic device is in a turn-on state;
based on identifying that the electronic device is not in a state of performing communication, identifying whether at least one external device connectable according to a preset communication method through the communication module is present;
based on identifying that the at least one external device is present, performing paring with the identified at least one external device in a background mode to establish a communication connection and acquiring communication connection information corresponding to the at least one external device; and
storing the acquired communication connection information, disconnecting the communication connection with the at least one external device, and switching to the standby mode.

13. The method as claimed in claim 11, further comprising:
based on the communication connection with the at least one external device whose communication connection information is stored being permitted according to a user command, performing communication without pairing with the at least one external device based on the communication connection information.

14. The method as claimed in claim 13, further comprising:
providing a UI including identification information for the at least one external device whose communication connection information is stored according to a user command; and
based on the communication connection with the at least one external device being permitted according to the user command received through the UI, performing communication without paring with the at least one external device based on the communication connection information.

15. A non-transitory computer-readable recording medium storing a computer instruction that, when executed by a processor of an electronic device, causes the electronic device to:
identify whether the electronic device is in a state of performing communication according to a preset communication method while in a standby mode;
based on identifying that the electronic device is not in a state of performing communication, identify whether at least one external device connectable according to a preset communication method through the communication module is present;
based on identifying that the at least one external device is present, wake up the electronic device; and
acquire communication connection information corresponding to the at least one external device at least by performing pairing with the identified at least one external device through at least the communication module, and store the acquired communication connection information.

16. The non-transitory computer-readable recording medium as claimed in claim 15, wherein the computer instruction, when executed by the processor, further causes the electronic device to:
store the acquired communication connection information in the memory, disconnect the communication connection with the at least one external device and switch to the standby mode.

17. The non-transitory computer-readable recording medium as claimed in claim 15, wherein the computer instruction, when executed by the processor, further causes the electronic device to:
identify whether the electronic device is in a state of performing communication according to the preset communication method while the electronic device is in a turn-on state;
based on identifying that the electronic device is not in a state of performing communication, identify whether at least one external device connectable according to a preset communication method through the communication module is present;
based on identifying that the at least one external device is present, perform paring with the identified at least one external device in a background mode to establish a communication connection and acquire communication connection information corresponding to the at least one external device; and
store the acquired communication connection information, disconnect the communication connection with the at least one external device, and switch to the standby mode.

18. The non-transitory computer-readable recording medium as claimed in claim 16, wherein the computer instruction, when executed by the processor, further causes the electronic device to:
based on the communication connection with the at least one external device whose communication connection information is stored being permitted according to a user command, perform communication without pairing with the at least one external device based on the communication connection information.

19. The non-transitory computer-readable recording medium as claimed in claim 18, wherein the computer instruction, when executed by the processor, further causes the electronic device to:
provide a UI including identification information for the at least one external device whose communication connection information is stored according to a user command; and
based on the communication connection with the at least one external device being permitted according to the user command received through the UI, perform communication without paring with the at least one external device based on the communication connection information.

20. The non-transitory computer-readable recording medium as claimed in claim 16, wherein the computer instruction, when executed by the processor, further causes the electronic device to:
wake up the electronic device based on a wake-up signal with a screen of a display turned off; and
perform pairing with the identified at least one external device to acquire communication connection information corresponding to the at least one external device.
